(19) United States
(12) Patent Application Publication
(10) Pub. No.: US 2025/0270361 A1
(43) Pub. Date: Aug. 28, 2025

(54) CHIRAL METAL OXIDE NANOSTRUCTURE, AND METHOD FOR PRODUCING SAME

(71) Applicant: EWHA UNIVERSITY-INDUSTRY COLLABORATION FOUNDATION, Seoul (KR)

(72) Inventors: Dong-Ha KIM, Seoul (KR); Minju KIM, Bucheon-si (KR)

(21) Appl. No.: 19/063,388

(22) Filed: Feb. 26, 2025

Related U.S. Application Data
(63) Continuation of application No. PCT/KR2023/009637, filed on Jul. 7, 2023.

(30) Foreign Application Priority Data
Aug. 31, 2022 (KR) 10-2022-0109875

(51) Int. Cl. C08F 293/00; B82B 3/00; B82Y 30/00; C01G 3/02; C01G 37/033; C01G 49/06; C01G 51/04

(52) U.S. Cl. CPC C08F 293/005; B82B 3/00; B82Y 30/00; C01G 3/02; C01G 37/033; C01G 49/06; C01G 51/04

(57) ABSTRACT

The present disclosure relates to a chiral metal oxide nanostructure and a method of preparing the same.

### TECHNICAL FIELD

The present disclosure relates to a chiral metal oxide nanostructure and a method of preparing the same.

### BACKGROUND

Chirality refers to geometric asymmetry that possesses non-superimposable mirror images. Chiral inorganic nanostructures, which are an extension of the concept of chirality, have attracted significant attention from various fields due to their high polarizability and strong chiro-optical responses. In particular, research on chiral metal oxide nanostructures has advanced considerably with the discovery of tunable chiro-optical responses in the UV-vis and near-infrared (NIR) regions as well as magnetic field-modulated magneto-chiroptic activities. The chiral metal oxide nanostructures can be applied to sensing, catalysts, nanophotonics, and optoelectronics.

In general, chiral metal oxide nanoparticles (NPs) with ligand-induced chirality have been synthesized using chiral amino acids as ligands. Chirality arises due to orbital coupling and Coulombic interactions between chiral ligands and inorganic surface, which induce chiral distortions in inorganic crystal lattices. However, mass production and finely tunable synthesis of chiral metal oxide nanostructures remain challenging. Further, considering that previous studies have focused on the evolution of chirality induced by chiral amino acids using solution-based growth methods, there remains a scientific demand to construct a broad library of chiral metal oxides and gain deeper insights into the origins of chirality by adopting various types of chiral molecules and synthetic strategies.

Block copolymers (BCPs) are macromolecules in which two or more chemically distinct polymer chains are linked by covalent bonds, and are widely recognized as bottom-up scaffolds for the fabrication of well-ordered inorganic nanostructures. BCP self-assembled structures can be tuned depending on molecular weight, composition, and selective affinity of solvent with respect to polymer blocks, and resultantly exhibit ordered morphologies, such as spheres, cylinders, gyroids, and lamellae. Interestingly, helical bias can be introduced through the co-assembly of achiral BCPs with chiral additives or by the self-assembly of polylactide-based BCPs containing both achiral and chiral blocks. Recently, chiral helical Au nanostructures have been fabricated using BCP helical structures. However, due to weak chirality transfer caused by inefficient interactions between chiral templates and inorganic nanostructures and incomplete preservation of helical morphology, weak chiro-optical properties with a g-factor of about 10⁻⁴ have been observed. Therefore, to fabricate chiral inorganic nanostructures with excellent chirality, it is important to develop novel chiral BCP self-assembled templates capable of efficiently transferring chirality.

Mandelic acid (MA) is a prototypical chiral molecule used in the asymmetric synthesis of pharmaceutical, cosmetic and drug molecules. Although MA exhibits high chelating ability toward metal ions, its chirality cannot be transferred to metal centers because it readily undergoes racemization in acidic, neutral, or basic media. Accordingly, MA has not been used as a chiral inducer for imparting chirality.

### PRIOR ART LITERATURE

Korean patent publication No. 10-2019-0134637

### DISCLOSURE OF THE INVENTION

### Problems to be Solved by the Invention

The present disclosure provides a chiral metal oxide nanostructure and a method of preparing the same.

However, problems to be solved by the present disclosure are not limited to the above-described problems. Although not described herein, other problems to be solved by the present disclosure can be clearly understood by a person with ordinary skill in the art from the following description.

### Means for Solving the Problems

A first aspect of the present disclosure provides a chiral metal oxide nanostructure, including regularly arranged metal oxide nanoparticles, wherein the metal oxide nanoparticles have a spherical shape.

A second aspect of the present disclosure provides a method of preparing the chiral metal oxide nanostructure according to the first aspect, including: a) adding a block copolymer and mandelic acid to a nonpolar solvent to prepare a first solution including a block copolymer/mandelic acid complex; b) adding a metal oxide precursor to the first solution to prepare a second solution; and c) treating the second solution with oxygen plasma to obtain the chiral metal oxide nanostructure.

### EFFECTS OF THE INVENTION

Chiral metal oxide nanostructures according to embodiments of the present disclosure can exhibit mirror-symmetric chiral optical properties with an asymmetry factor of up to 4.7×10⁻³ in the visible and near-infrared regions.

The chiral metal oxide nanostructures according to embodiments of the present disclosure can be used as iron, cobalt, and chromium oxide nanostructures that exhibit chiral properties in the visible region and as copper oxide nanostructures that exhibit optical properties in the infrared region.

Paramagnetic chiral metal oxide nanostructures according to embodiments of the present disclosure can serve as optically active materials for optoelectronic and spintronic devices because their chiral optical properties can be modulated depending on the direction of an external magnetic field.

A method of fabricating chiral metal oxide nanostructures according to embodiments of the present disclosure can suppress the racemization of MA while using MA as a chiral inducer to impart chirality to the nanostructures.

The method of fabricating chiral metal oxide nanostructures according to embodiments of the present disclosure enables an effective hierarchical chirality transfer from molecular chirality of MA to supramolecular chirality of a block copolymer/MA complex, and further from a metal complex to a metal oxide nanostructure through interactions between the block copolymer/MA complex and metal ions.

The method of fabricating chiral metal oxide nanostructures according to embodiments of the present disclosure is a generalized fabrication method using MA as a chiral inducer, and can fabricate various metal oxide nanostructures by allowing chelation of MA with various metals.

The method of fabricating chiral metal oxide nanostructures according to embodiments of the present disclosure is cost effective, simple, and scalable for large area and mass production and thus can be applied to chiral sensing, chiral catalysis, chiral optics, and magnetic devices.

The method of fabricating chiral metal oxide nanostructures according to embodiments of the present disclosure can fabricate chiral inorganic nanostructures and hybrid nanostructures with tunable shapes and morphologies by controlling BCP self-assembled structures depending on molecular weight, composition ratio, solvent or etc.

### BRIEF DESCRIPTION OF THE DRAWINGS

FIG. 1 is a schematic diagram illustrating a method of fabricating chiral metal oxide nanostructures according to an example of the present disclosure.

FIG. 2A is a graph showing the circular dichroism (CD) spectra and corresponding absorption spectra of P4VP/R-MA complex, P4VP/S-MA complex, and pure P4VP in toluene according to an example of the present disclosure, FIG. 2B shows the CD spectra and corresponding absorption spectra of R/S-MA in isopropyl alcohol according to an example of the present disclosure, and FIG. 2C shows the CD spectra and corresponding absorption spectra of PS-b-P4VP, PS-b-P4VP/R-MA, and PS-b-P4VP/S-MA in toluene according to an example of the present disclosure.

FIG. 3 shows the Fourier transform infrared (FTIR) spectroscopy spectra of PS-b-P4VP, MA, and the PS-b-P4VP/MA according to an example of the present disclosure.

FIG. 4 shows a chemical reaction equation showing a proton transfer from MA to pyridine of P4VP via hydrogen bonding between P4VP and MA according to an example of the present disclosure.

FIG. 5A to FIG. 5C are atomic force microscopy (AFM) images of PS-b-P4VP, PS-b-P4VP/R-MA, and PS-b-P4VP/S-MA, respectively, according to an example of the present disclosure.

FIG. 6A to FIG. 6D are transmission electron microscopy (TEM) images of block copolymer (BCP)/mandelic acid (MA)/metal oxide precursor complexes observed after respective FeCl₃, CoCl₂, CrCl₃, and CuCl₂ are added as metal oxide precursors to a PS-b-P4VP/MA solution according to an example of the present disclosure.

FIG. 7Ai and FIG. 7Aii, FIG. 7Bi and FIG. 7Bii, FIG. 7Ci and FIG. 7Cii, and FIG. 7Di and FIG. 7Dii are graphs showing the CD spectra, optical extinction spectra, and g-factors of BCP/R-MA/Fe and BCP/S-MA/Fe; BCP/R-MA/Co and BCP/S-MA/Co; BCP/R-MA/Cr and BCP/S-MA/Cr; and BCP/R-MA/Cu and BCP/S-MA/Cu, respectively, according to an example of the present disclosure.

FIG. 8A to FIG. 8E show the FT-IR spectroscopy spectra of BCP/MA, BCP/MA/Fe, BCP/MA/Co, BCP/MA/Cr, and BCP/MA/Cu, respectively, according to an example of the present disclosure.

FIG. 9A to FIG. 9D are TEM images of chiral Fe₂O₃, chiral Co₃O₄, chiral CrO₂, and chiral CuO nanoparticles, respectively, according to an example of the present disclosure.

FIG. 10A to FIG. 10D are X-ray diffraction (XRD) graphs of chiral Fe₂O₃, chiral Co₃O₄, chiral CrO₂, and chiral CuO nanoparticles, respectively, according to an example of the present disclosure.

FIG. 11Ai and FIG. 11Aii, FIG. 11Bi and FIG. 11Bii, FIG. 11Ci and FIG. 11Cii, and FIG. 11Di and FIG. 11Dii are graphs showing the CD spectra, optical extinction spectra, and g-factors of R—Fe₂O₃ and S—Fe₂O₃ nanoparticles; R—Co₃O₄ and S—Co₃O₄ nanoparticles; R—CrO₂ and S-CrO₂ nanoparticles; and R-CuO and S-CuO nanoparticles, respectively, according to an example of the present disclosure.

FIG. 12A to FIG. 12D are graphs showing Tauc plots of chiral Fe₂O₃, chiral Co₃O₄, chiral CrO₂, and chiral CuO nanoparticles, respectively, according to an example of the present disclosure.

FIG. 13A to FIG. 13D are X-ray photoelectron spectroscopy (XPS) graphs of chiral Fe₂O₃, chiral Co₃O₄, chiral CrO₂, and chiral CuO nanoparticles, respectively, according to an example of the present disclosure.

FIG. 14A and FIG. 14B are graphs showing the total CD spectra of chiral Fe₂O₃ nanoparticles grown on PS-b-P4VP/R-MA and PS-b-P4VP/S-MA reverse micelle templates, respectively, (where the term “NCD (Nature CD)” represents the difference in absorption coefficients of circularly polarized light in the absence of a magnetic field) according to an example of the present disclosure, and FIG. 14C and FIG. 14D show the magnetic circular dichroism (MCD) spectra of chiral Fe₂O₃ nanoparticles grown on PS-b-P4VP/R-MA and PS-b-P4VP/S-MA reverse micelle templates, respectively, according to an example of the present disclosure.

FIG. 15A and FIG. 15B are graphs showing the total CD spectra of chiral Co₃O₄ nanoparticles grown on PS-b-P4VP/R-MA and PS-b-P4VP/S-MA reverse micelle templates, respectively, according to an example of the present disclosure, and FIG. 15C and FIG. 15D show the MCD spectra of chiral Co₃O₄ nanoparticles grown on PS-b-P4VP/R-MA and PS-b-P4VP/S-MA reverse micelle templates, respectively, according to an example of the present disclosure.

FIG. 16A to FIG. 16D are graphs showing the CD spectra and optical extinction spectra of R-MA/Fe and S-MA/Fe; R-MA/Co and S-MA/Co; R-MA/Cr and S-MA/Cr; and R-MA/Cu and S-MA/Cu complexes, respectively, according to an example of the present disclosure.

FIG. 17A to FIG. 17D are graphs showing the CD spectra and optical extinction spectra of P4VP/R-MA/Fe and P4VP/S-MA/Fe; P4VP/R-MA/Co and P4VP/S-MA/Co; P4VP/R-MA/Cr and P4VP/S-MA/Cr; and P4VP/R-MA/Cu and P4VP/S-MA/Cu complexes, respectively, according to an example of the present disclosure.

FIG. 18 is a schematic diagram illustrating the hierarchical chirality transfer mechanism in a process of fabricating chiral metal oxide nanostructures according to an example of the present disclosure.

### BEST MODE FOR CARRYING OUT THE INVENTION

Hereafter, embodiments of the present disclosure will be described in detail with reference to the accompanying drawings. However, it is to be noted that the present disclosure is not limited to the embodiments but can be embodied in various other ways. Also, the accompanying drawings are provided to help easily understand the embodiments of the present disclosure and the technical conception described in the present disclosure is not limited by the accompanying drawings. In the drawings, parts irrelevant to the description are omitted for the simplicity of explanation, and like reference numerals denote like parts through the whole document.

Through the whole document, the term “connected to” or “coupled to” that is used to designate a connection or coupling of one element to another element includes both a case that an element is “directly connected or coupled to” another element and a case that an element is “electronically connected or coupled to” another element via still another element.

Through the whole document, the term “on” that is used to designate a position of one element with respect to another element includes both a case that the one element is adjacent to the other element and a case that any other element exists between these two elements.

Further, through the whole document, the term “comprises or includes” and/or “comprising or including” used in the document means that one or more other components, steps, operation and/or existence or addition of elements are not excluded in addition to the described components, steps, operation and/or elements unless context dictates otherwise.

Through the whole document, the term “about or approximately” or “substantially” is intended to have meanings close to numerical values or ranges specified with an allowable error and intended to prevent accurate or absolute numerical values disclosed for understanding of the present disclosure from being illegally or unfairly used by any unconscionable third party.

Through the whole document, the term “step of” does not mean “step for”.

Through the whole document, the term “combination of” included in Markush type description means mixture or combination of one or more components, steps, operations and/or elements selected from a group consisting of components, steps, operation and/or elements described in Markush type and thereby means that the disclosure includes one or more components, steps, operations and/or elements selected from the Markush group.

Through this whole specification, a phrase in the form “A and/or B” means “A or B, or A and B”.

Hereinafter, embodiments and examples of the present disclosure will be described in detail with reference to the accompanying drawings. However, the present disclosure may not be limited to the following embodiments, examples, and drawings.

A first aspect of the present disclosure provides a chiral metal oxide nanostructure, including regularly arranged metal oxide nanoparticles, and the metal oxide nanoparticles have a spherical shape.

In an embodiment of the present disclosure, a metal contained in the chiral metal oxide nanostructure may be at least one selected from Fe, Co, Cr, Cu, Ti, V, Mn, Ni, Zn, Zr, Nb, Mo, Ru, Rh, Pd, Ag, Cd, Hf, Ta, W, Ir, Pt, Au, In, Sn, Sb, Pb and Bi, but is not limited thereto. In an embodiment of the present disclosure, a metal contained in the chiral metal oxide nanostructure may be Fe, Co, Cr, or Cu. In an embodiment of the present disclosure, the chiral metal oxide nanostructure may be Fe₂O₃, Co₃O₄, CrO₂, or CuO, but is not limited thereto.

In an embodiment of the present disclosure, a crystal structure of the metal oxide nanoparticles may be selected from cubic, orthorhombic, and monoclinic structures, but is not limited thereto.

In an embodiment of the present disclosure, a diameter of the metal oxide nanoparticles may be about 10 nm to about 100 nm, but is not limited thereto. In an embodiment of the present disclosure, a diameter of the metal oxide nanoparticles may be about 10 nm to about 100 nm, about 10 nm to about 90 nm, about 10 nm to about 80 nm, about 10 nm to about 70 nm, about 15 nm to about 100 nm, about 15 nm to about 90 nm, about 15 nm to about 80 nm, about 15 nm to about 70 nm, about 20 nm to about 100 nm, about 20 nm to about 90 nm, about 20 nm to about 80 nm, or about 20 nm to about 70 nm. In an embodiment of the present disclosure, a diameter of the metal oxide nanoparticles may be about 23 nm, about 28 nm, about 55 nm, or about 60 nm.

In an embodiment of the present disclosure, the chiral metal oxide nanostructure may exhibit chiro-optical properties.

In an embodiment of the present disclosure, a g-factor of the chiral metal oxide nanostructure is about 4.7×10⁻³, but can be significantly improved through optimization of sample thickness or etc.

In an embodiment of the present disclosure, the chiral metal oxide nanostructure may be applied in chiral sensing, chiral catalysis, chiral devices, chiral materials, and chiral optics, but is not limited thereto.

A second aspect of the present disclosure provides a method of preparing the chiral metal oxide nanostructure according to the first aspect, including: a) adding a block copolymer and mandelic acid(MA) to a nonpolar solvent to prepare a first solution including a block copolymer/mandelic acid(MA) complex; b) adding a metal oxide precursor to the first solution to prepare a second solution; and c) treating the second solution with oxygen plasma to obtain the chiral metal oxide nanostructure.

Detailed descriptions of the second aspect of the present disclosure, which overlap with those of the first aspect of the present disclosure, are omitted hereinafter, but the descriptions of the first aspect of the present disclosure may be identically applied to the second aspect of the present disclosure, even though they are omitted hereinafter.

In an embodiment of the present disclosure, the block copolymer may be composed of a combination of a nonpolar polymer and a polar polymer, or a combination of a nonpolar polymer and a hydrophilic polymer.

In an embodiment of the present disclosure, the block copolymer may include at least one selected from polystyrene-block-poly(4-vinyl pyridine) (PS-b-P4VP), polystyrene-block-poly (methylmethacrylate) (PS-b-PMMA), polystyrene-block-poly(ethylene oxide) (PS-b-PEO), polystyrene-block-poly(vinyl pyridine) (PS-b-PVP), polystyrene-block-poly(acrylic acid) (PS-b-PAA), polystyrene-block-polyisoprene (PS-b-PI), and a block copolymer containing a polar polymer or a hydrophilic polymer, but is not limited thereto. In an embodiment of the present disclosure, the block copolymer may be polystyrene-block-poly (4-vinyl pyridine) (PS-b-P4VP).

In an embodiment of the present disclosure, the MA may be selected from R-MA and S-MA, but is not limited thereto. In an embodiment of the present disclosure, when R-MA is used, the block copolymer/MA complex may be right-handed. In an embodiment of the present disclosure, when S-MA is used, the block copolymer/MA complex may be left-handed.

In an embodiment of the present disclosure, when the PS-b-P4VP is used as the block copolymer, the block copolymer/MA complex may be PS-b-P4VP/R-MA or PS-b-P4VP/S-MA.

In an embodiment of the present disclosure, the MA may act as a chiral dopant.

In an embodiment of the present disclosure, a molar ratio of the block copolymer to the MA (block copolymer: MA) may be about 1:2, but is not limited thereto.

In an embodiment of the present disclosure, the nonpolar solvent may include one or more selected from toluene, acetone, benzene, xylene, chloroform, tetrahydrofuran, dimethylformamide, and isopropanol, but is not limited thereto. In an embodiment of the present disclosure, the nonpolar solvent may be toluene.

In an embodiment of the present disclosure, a metal contained in the metal oxide precursor and the chiral metal oxide nanostructure may include at least one selected from Fe, Co, Cr, Cu, Ti, V, Mn, Ni, Zn, Zr, Nb, Mo, Ru, Rh, Pd, Ag, Cd, Hf, Ta, W, Ir, Pt, Au, In, Sn, Sb, Pb and Bi, but is not limited thereto. In an embodiment of the present disclosure, a metal contained in the metal oxide precursor and the chiral metal oxide nanostructure may be Fe, Co, Cr, or Cu, but is not limited thereto. In an embodiment of the present disclosure, a metal salt containing the metal oxide precursor may be FeCl₃, CoCl₂, CrCl₃, or CuCl₂, but is not limited thereto. In an embodiment of the present disclosure, the chiral metal oxide nanostructure may be Fe₂O₃, CO₃O₄, CrO₂, or CuO, but is not limited thereto.

In an embodiment of the present disclosure, a molar ratio of the block copolymer to the metal oxide precursor (block copolymer: metal oxide precursor) may be about 2:1, but is not limited thereto.

In an embodiment of the present disclosure, the block copolymer/MA complex may have a reverse micelle structure.

In an embodiment of the present disclosure, the block copolymer/MA complex may have a core-shell structure. In an embodiment of the present disclosure, when the PS-b-P4VP is used as the block copolymer, the core may be P4VP/MA and the shell may be PS. In an embodiment of the present disclosure, a size of the reverse micelles may be from several tens of nanometers to 200 nm.

In an embodiment of the present disclosure, the block copolymer/MA complex may have a significant steric hindrance caused by complexation of the block copolymer and the MA, and the steric hindrance may cause the formation of helical block copolymer chains.

In an embodiment of the present disclosure, when the PS-b-P4VP is used as the block copolymer, hydrogen bonding between pyridine of the PS-b-P4VP and a carboxyl group of the MA may occur. In an embodiment of the present disclosure, when the PS-b-P4VP is used as the block copolymer, ionic bonding between pyridine of the PS-b-P4VP and a carboxyl group of the MA may occur. In an embodiment of the present disclosure, molecular chirality of the MA may evolve into supramolecular chirality of the P4VP due to the hydrogen bonding and the ionic bonding.

In an embodiment of the present disclosure, the process b) may include adding the metal oxide precursor to dimethylformamide (N,N-dimethylformamide).

In an embodiment of the present disclosure, in the process b), a block copolymer (BCP)/MA/metal oxide complex may be generated. In an embodiment of the present disclosure, the BCP/MA/metal oxide complex may include one or more selected from BCP/R-MA/Fe, BCP/S-MA/Fe, BCP/R-MA/Co, BCP/S-MA/Co, BCP/R-MA/Cr, BCP/S-MA/Cr, BCP/R-MA/Cu, or BCP/S-MA/Cu, but is not limited thereto. In an embodiment of the present disclosure, the BCP/R-MA/Cu or BCP/S-MA/Cu may have a nanoring structure. In an embodiment of the present disclosure, Cu contained in the BCP/R-MA/Cu or BCP/S-MA/Cu may be selectively distributed at an edge of a BCP/MA core.

In an embodiment of the present disclosure, when the PS-b-P4VP is used as the block copolymer, the BCP/MA/metal complex prepared in the process b) may be selected from PS-b-P4VP/R-MA/Fe, PS-b-P4VP/S-MA/Fe, PS-b-P4VP/R-MA/Co, PS-b-P4VP/S-MA/Co, PS-b-P4VP/R-MA/Cr, PS-b-P4VP/S-MA/Cr, PS-b-P4VP/R-MA/Cu, and PS-b-P4VP/S-MA/Cu, but is not limited thereto.

In an embodiment of the present disclosure, the process c) may further include drop-casting the second solution, evaporating the solvent, and performing oxygen plasma treatment to obtain the chiral metal oxide nanostructure.

In an embodiment of the present disclosure, the method of fabricating the chiral metal oxide nanostructure may utilize BCP self-assembly.

In an embodiment of the present disclosure, the method of fabricating the chiral metal oxide nanostructure may be applied to mass production.

Hereinafter, the present disclosure will be explained in more detail with reference to Examples. However, the following Examples are illustrated only for better understanding of the present disclosure but do not limit the present disclosure.

### MODE FOR CARRYING OUT THE INVENTION

### Examples

### Example 1

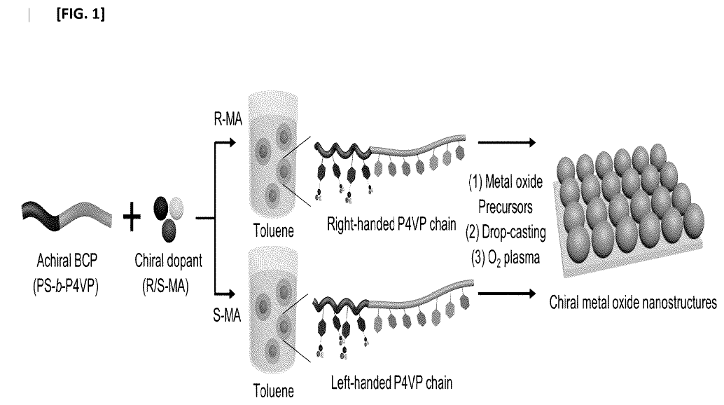

### Fabrication of Chiral Metal Oxide Nanostructure (FIG. 1)

Polystyrene-block-poly(4-vinyl pyridine) (PS-b-P4VP, M_{n,Ps}=41 kg mol⁻¹, M_{n,P4VP}=24 kg mol⁻¹) was purchased from Polymer Source. Poly(4-vinyl pyridine) (Mₙ=60 kg mol⁻¹), iron(III) chloride hexahydrate (ACS reagent, 97%), cobalt(II) chloride (97%), chromium(III) chloride (refined by sublimation, 99%), copper(II) chloride dihydrate (ACS reagent, ≥99.0%), N,N-dimethylformamide (DMF, anhydrous, 99.8%), and toluene (anhydrous, 99.8%) were purchased from Sigma-Aldrich. (R)-(−)-MA (R-MA, 98%) and(S)-(+)-MA (S-MA, ≥99.0%) were purchased from Thermo Scientific Chemicals, and isopropyl alcohol (99.7%) was purchased from Daejung Chemicals.

### 1-1. Preparation of Block Copolymer/Mandelic Acid Complex (BCP/MA)

5 mg of PS-b-P4VP (M_{n,PS}=41 kg mol⁻¹, M_{n,P4VP}=24 kg mol⁻¹) and 5 mg of R/S-MA were dissolved in 1 mL of toluene with stirring at 80° C. for 24 hours. The molar ratio of P4VP to MA was 1:2. Through complexation of PS-b-P4VP with R/S-MA, expanded spherical reverse micelles each composed of a P4VP/MA core and a PS shell were formed and a significant steric hindrance caused the formation of helical P4VP chains.

### 1-2. Fabrication of Chiral Metal Oxide Nanostructure Using Metal Oxide Precursor in BCP/MA Complex (BCP/MA/M)

A metal oxide precursor including FeCl₃, CoCl₂, CrCl₃, and CuCl₂ (molar ratio of P4VP and metal oxide precursor=2:1) was dissolved in 30 μl of dimethylformamide (N,N-dimethylformamide; DMF) and then added to the PS-b-P4VP/MA mixed solution prepared in the process 1-1. The solution was stirred vigorously for 3 days to allow sufficient time for the metal oxide precursors to diffuse into the internal P4VP/DL-ala micelle cores, and a metal oxide precursor-incorporated BCP/MA complex solution. The solution was uniformly drop-cast onto a 25 mm×25 mm quartz substrate placed on a hot plate maintained at 50° C. and covered with a glass beaker to allow slow evaporation of toluene under toluene vapor at 50° C. Subsequently, oxygen plasma (O₂ plasma) treatment (50 sccm gas, 100 W) was performed for 30 minutes to convert the metal oxide precursor into a metal oxide nanostructure and remove a polymer template. As a result, a highly ordered nanodot-patterned chiral metal oxide nanostructure was obtained.

### 2. Analysis of BCP/MA Complex (PS-b-P4VP/(R or S−)MA)

The tools used for analyzing the BCP/MA complex, the BCP/MA/metal oxide precursor complex, and the chiral metal oxide nanostructure prepared in the processes 1-1 and 1-2 were as follows: Transmission electron microscopy (TEM) and atomic force microscopy (AFM) measurements were performed using a JEM-2100Plus (JEOL) and Dimension Edge AFM (Bruker), respectively. FTIR spectra were obtained using an INVENIO-R FTIR spectrometer (Bruker) with KBr pellet technique, and X-ray diffraction (XRD) patterns were obtained using an SPIN-1200D X-ray diffractometer (EPLEX) with Ni-filtered Cu-Ka radiation (λ=1.5418 Å). X-ray photoelectron spectroscopy (XPS) was performed using a Thermo Scientific K-Alpha XPS with a dual beam source. Circular dichroism (CD) and absorption spectra were recorded using a JASCO J-1500 CD spectrometer. UV-vis-NIR diffuse reflectance studies were performed using a UV-vis-NIR spectrophotometer (Cary 5000, Varian). The bandgap energy was determined from the x-axis intercept of a linear fit of a Tauc plot. Magnetic circular dichroism (MCD) spectra were measured using a J-1700 spectropolarimeter (JASCO) equipped with a 1.6 T permanent magnet (Tesla) under a parallel or antiparallel magnetic field.

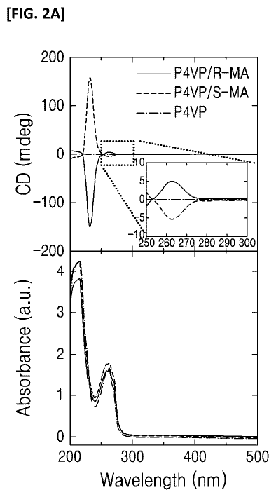

### 2-1. Circular Dichroism and Absorption Spectra (FIG. 2A to FIG. 2C)

To confirm the chirality of the BCP/MA complex, UV-vis absorption and circular dichroism (CD) spectra were analyzed.

Referring to FIG. 2A, the P4VP did not exhibit a CD signal around an absorption peak at 262 nm, which was caused by a π-π* transition of a pyridine ring. However, after complexation with the MA, a mirror-image CD spectrum with a split-type Cotton effect was observed. In the case of the P4VP/R-MA complex, a positive Cotton effect occurred at the absorption peak and a right-handed helical P4VP chain was formed, whereas in the case of the P4VP/S-MA complex, a negative Cotton effect occurred and a left-handed P4VP chain was formed.

Referring to the CD spectrum of R/S-MA in FIG. 2B, a strong Cotton effect at 230 nm was attributed to an π-π* transition of the carboxylic acid in MA. However, due to complexation with the P4VP, a CD peak of the MA underwent a bathochromic shift from 224 nm to 230 nm.

Referring to FIG. 2C, the PS-b-P4VP/MA complex exhibited a mirror-image CD response similar to that of the P4VP/MA complex. Due to strong complexation between the P4VP and the MA in the restricted micelle environment, CD peaks corresponding to transitions of the pyridine and the MA were shifted to lower energy levels. These results suggest that the molecular chirality of the MA can evolve into the structural chirality of the P4VP chain through complexation.

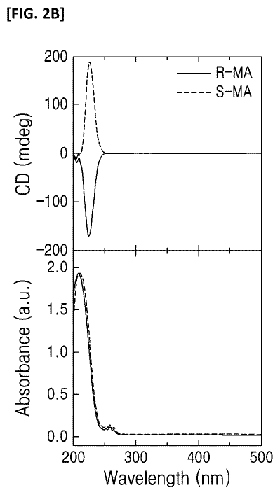

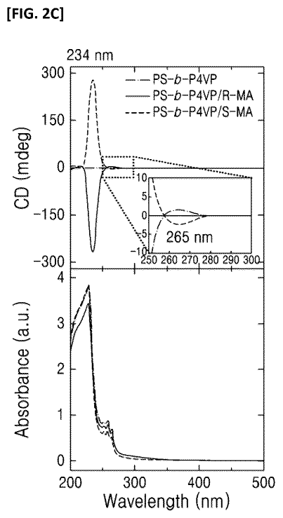

### 2-2. Fourier Transform Infrared Spectroscopy (FTIR) (FIG. 3 and FIG. 4)

Fourier transform infrared spectroscopy (FTIR) was performed to analyze the bonding structure of the BCP/MA complex. Referring to FIG. 3 and FIG. 4, two characteristic absorption bands at 1556 cm⁻¹ and 1602 cm⁻¹ corresponding to vibrational modes of pyridine rings in P4VP were broadened in the presence of the MA and shifted to higher wavenumbers (1561 cm⁻¹ and 1605 cm⁻¹, respectively). The stretching vibration of a C═O group was shifted from 1724 cm⁻¹ in pure MA to 1730 cm⁻¹ in the PS-b-P4VP/MA complex, which confirmed that hydrogen bonding occurred between a carboxyl group of the MA and lone pair electrons of the pyridine. Also, it can be seen that a new absorption peak observed at 1635 cm⁻¹ in the PS-b-P4VP/MA complex is caused by the C═NH⁺ stretching mode of the pyridine, generated by a proton transfer via hydrogen bonding and this indicates that a partial positive charge is imparted to nitrogen of the pyridine, as shown in FIG. 4. Therefore, not only hydrogen bonding but also relatively stronger ionic interactions can serve as bridges to transfer chirality from the molecular to the supramolecular level.

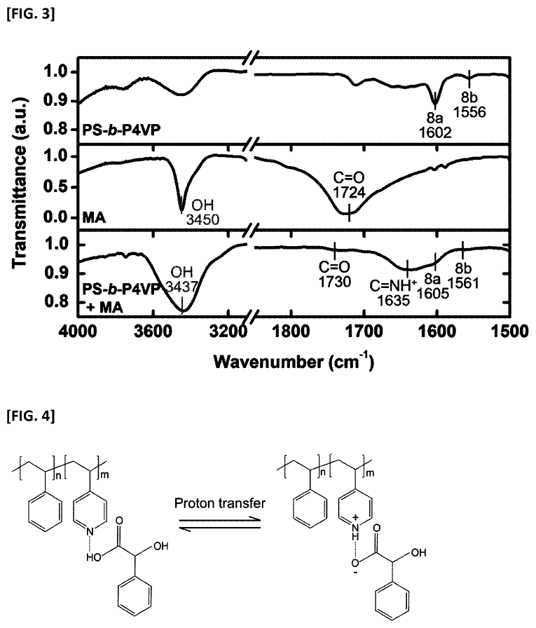

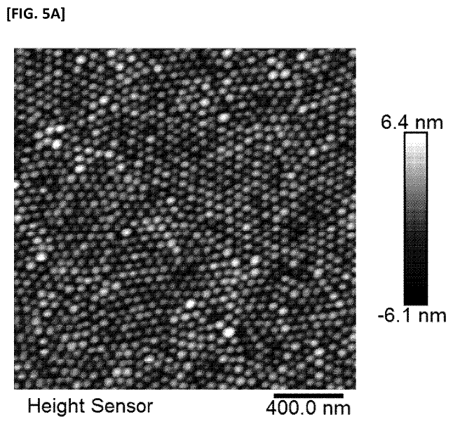

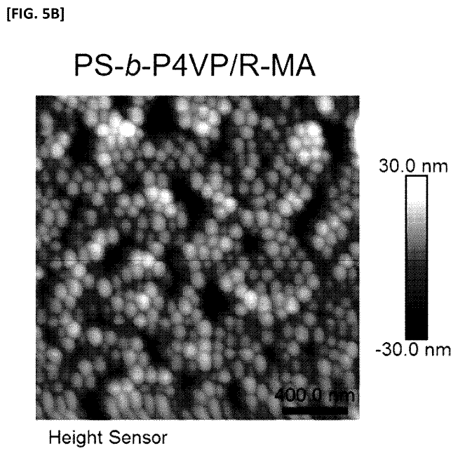

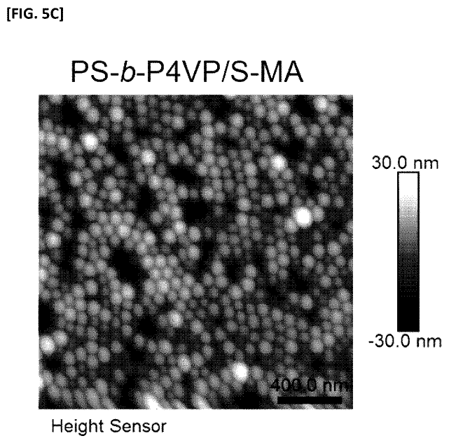

### 2-3. Atomic Force Microscopy (AFM) Analysis (FIG. 5A to FIG. 5C)

The morphology of the BCP/MA complex was analyzed by atomic force microscopy (AFM).

When PS-b-P4VP was dissolved in toluene, spherical reverse micelles each having a diameter of 60 nm and composed of a PS shell and a P4VP core were formed. A monolayer of these hexagonally arranged reverse micelles was observed on a film spin-coated on a Si substrate (FIG. 5A). Subsequently, after R/S-MA was added and then complexed with PS-b-P4VP, reverse micelles each composed of a PS shell and a P4VP/MA core were formed to have a greater size of 80 nm than the spherical reverse micelles (PS-b-P4VP) (FIG. 5B and FIG. 5C). Therefore, through complexation of PS-b-P4VP with R/S-MA, the bulky chiral dopant R/S-MA was embedded into the reverse micelles and expanded reverse micelles were formed, which means that a significant steric hindrance was induced.

### 3. Analysis of BCP/MA/Metal Oxide Complex (PS-b-P4VP/(R or S−)MA/Metal Oxide Precursor)

Herein, the properties of the metal oxide precursor-incorporated BCP/MA complex obtained in the process described in Section 1-2 were analyzed.

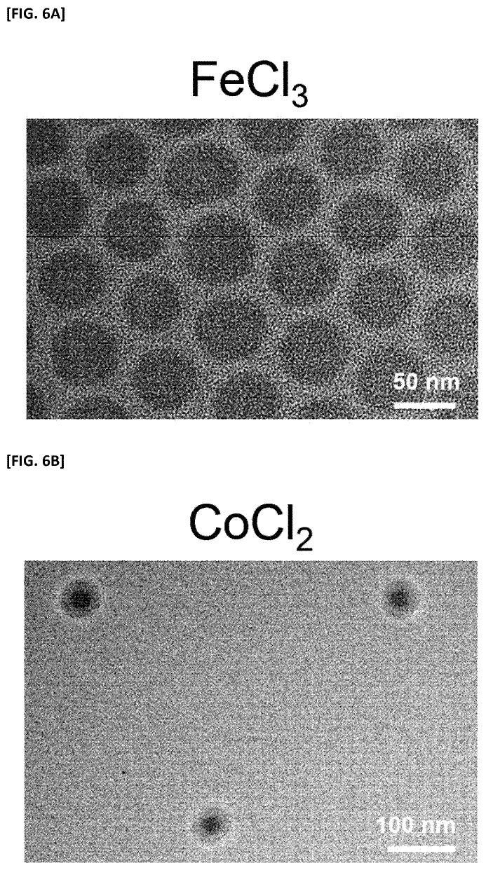

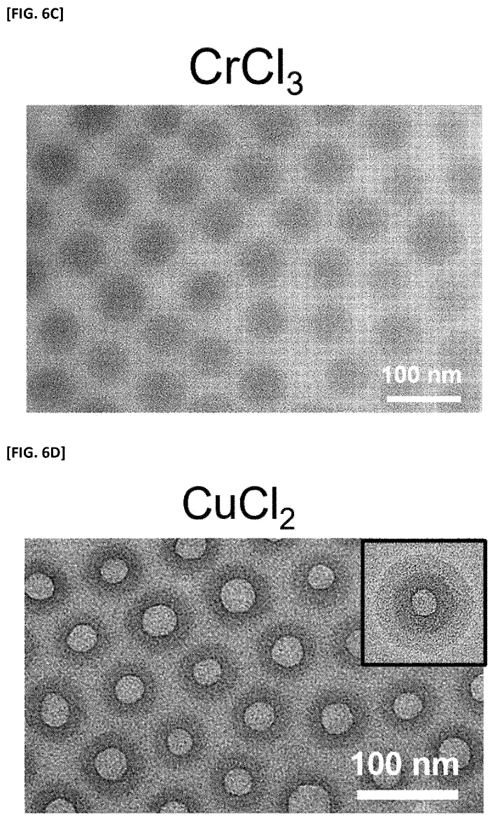

### 3-1. Transmission Electron Microscopy (TEM) Analysis (FIG. 6A to FIG. 6D)

To confirm the capability of PS-b-P4VP/MA reverse micelles as chiral templates for the synthesis of chiral metal oxide nanostructures, various metal oxide precursors including FeCl₃, CoCl₂, and CrCl₃ were mixed with a PS-b-P4VP/MA solution. Metal oxide precursors (FeCl₃, CoCl₂, CrCl₃, and CuCl₂) were added to the BCP/MA complex solution and the structure was analyzed by transmission electron microscopy (TEM). In the case of FeCl₃, CoCl₂, and CrCl₃, the metal oxide precursors were selectively distributed within the P4VP/MA core and dark micelle cores were observed (FIG. 6A to FIG. 6C). Also, in the case of CuCl₂, Cu²⁺ ions reacted with free MA to generate protons and the protonation of P4VP was induced. Due to a steric hindrance and electrostatic repulsive force, Cu²⁺ ions were selectively distributed at an edge of the P4VP/MA core (FIG. 6D). The Cu²⁺ precursor was selectively embedded into the P4VP/MA domain and arranged at an edge of the micelle core. Thus, a unique nanoring pattern with inner and outer average diameters of 30 nm and 70 nm, respectively, was formed.

Typically, to form nanoring structures by utilizing PS-b-PVP self-assembly, a solvent-induced surface reconstruction was used, i.e., a BCP film composed of a PVP nanodomain and a PS matrix was immersed in ethanol, which is a selective solvent for a PVP block. In contrast, the nanoring pattern in the present example was generated immediately after interactions between PS-b-P4VP/MA reverse micelles and CuCl₂ in a nonpolar solvent. The formation mechanism of the nanoring pattern involves four sequential processes: (1) As previously demonstrated with the highest metal-mandelate stability constant among conventionally reported metal-mandelate complexes, protons are dissociated from free MA due to a high chelation ability of mandelate with respect to Cu²⁺ ions and a copper-mandelate complex is easily formed; (2) An inner P4VP block absorbs the protons and is actively protonated; (3) Meanwhile, Cu²⁺ ions are attached to an edge of the P4VP/MA core through strong coordination; (4) However, electrostatic repulsion between the protonated inner P4VP block and Cu²⁺ ions suppresses embedment of Cu²⁺ ions into the center of the micelle core.

The diameters of the P4VP/MA cores containing Fe³⁺, Co²⁺, and Cr³⁺ ions were measured to be 55 nm, 28 nm, and 60 nm, respectively.

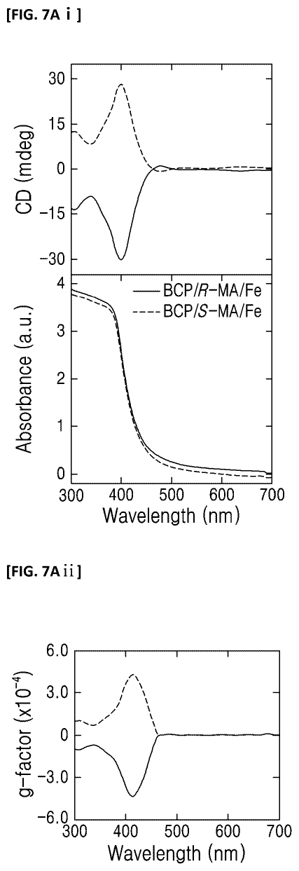

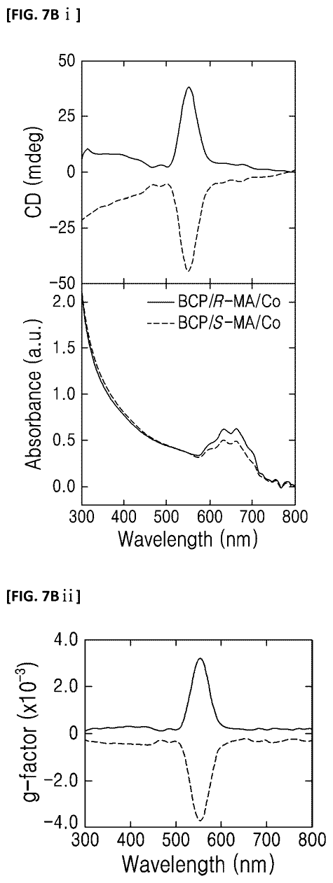

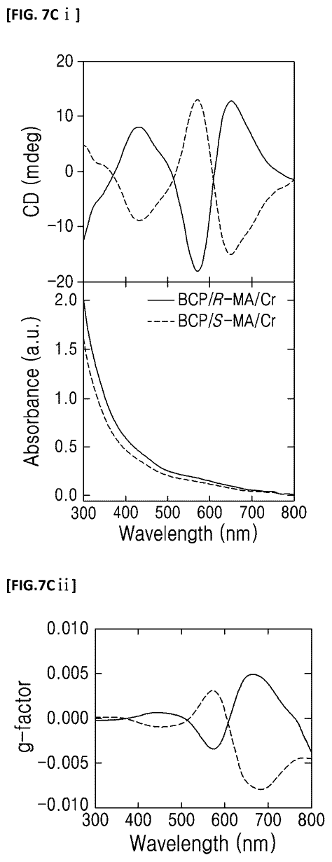

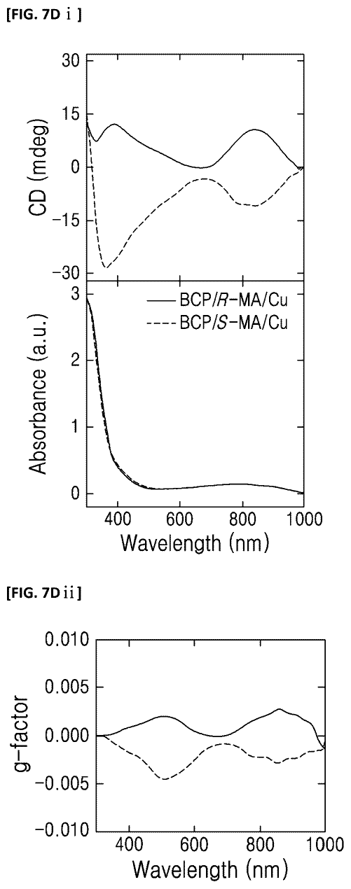

3-2. Circular Dichroism Spectrum, Optical Extinction Spectrum, and G-Factor (Asymmetry Factor) (FIG. 7Ai and FIG. 7Aii, FIG. 7Bi and FIG. 7Bii, FIG. 7Ci and FIG. 7Cii, and FIG. 7Di and FIG. 7Dii)

FIG. 7Ai and FIG. 7Aii, FIG. 7Bi and FIG. 7Bii, FIG. 7Ci and FIG. 7Cii,

and FIG. 7Di and FIG. 7Dii show the CD spectra, optical extinction spectra, and g-factors of the metal oxide precursor-incorporated BCP/MA complex. Spectroscopic measurements in the UV region were not performed due to the cut-off effect of toluene.

As shown in FIG. 7Ai and FIG. 7Aii, for the chiral PS-b-P4VP/MA reverse micelles containing Fe³⁺ ions, an absorption band was observed near 380 nm corresponding to a ligand-to-metal charge transfer (LMCT) transition. The CD spectrum exhibited a g-factor of 4.3×10⁻⁴at 400 nm.

As shown in FIG. 7Bi and FIG. 7Bii, for the chiral PS-b-P4VP/MA reverse micelles containing Co²⁺ ions, an absorption band appeared near 650 nm due to LMCT and d-d transitions, and a mirror-symmetric circular dichroism signal was observed at 550 nm. The maximum g-factor was measured to be 3.7×10³ at 550 nm.

As shown in FIG. 7Ci and FIG. 7Cii, for the chiral PS-b-P4VP/MA reverse micelles containing Cr³⁺ ions, absorption bands ranging from 300 nm to 370 nm, from 370 nm to 510 nm, and from 510 nm to 610 nm correspond to ⁴A_{2g}-⁴T_{1g}, ⁴A_{2g}-⁴T_{1g}, and ⁴A_{2g}-⁴T_{2g}d-d transitions of Cr³⁺ ions, respectively, and weak absorption observed in a range of from 610 nm to 1000 nm corresponds to a spin-allowed transition. The CD spectrum exhibited a strong Cotton effect in each transition band with mirror symmetry, and the maximum g-factor was measured to be 8.1×10³ in the spin-allowed transition.

As shown in FIG. 7Di and FIG. 7Dii, for the chiral PS-b-P4VP/MA reverse micelles containing Cu²⁺ ions, a distinct absorption band was observed in a range of from 300 nm to 400 nm corresponding to a LMCT transition and a broad absorption band appeared in a spectral range of from 600 nm to 1000 nm corresponding to a d-d transition of Cu²⁺ ions. The CD spectrum exhibited two intense peaks within the absorption region including the vis-NIR range, and the maximum g-factor was measured to be 4.5×10⁻³ at 510 nm.

From the results shown in FIG. 7Ai and FIG. 7Aii, FIG. 7Bi and FIG. 7Bii, FIG. 7Ci and FIG. 7Cii, and FIG. 7Di and FIG. 7Dii, it was confirmed that supramolecular chirality was successfully transferred to the center of the metal embedded into the P4VP/MA core.

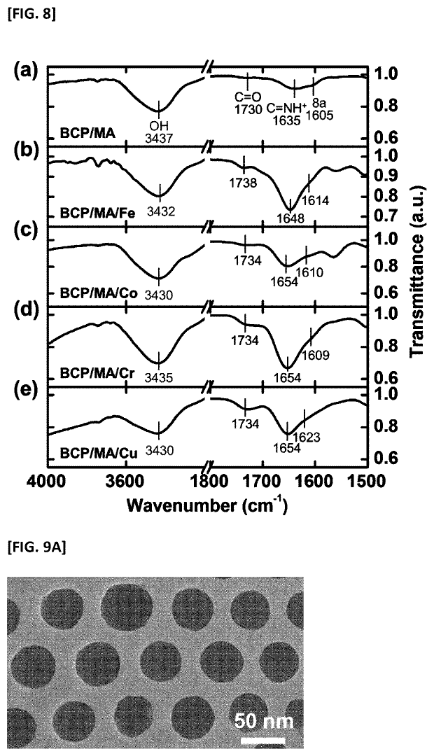

### 3-3. FTIR Analysis (FIG. 8A to FIG. 8E)

FTIR was performed to analyze non-covalent interactions between P4VP/MA and metal ions which enable chiral transfer. A shift of the O—H band in FIG. 8A to lower wavenumbers in FIG. 8B to FIG. 8E confirms that PS-b-P4VP/MA is chelated to metal ions through the O—H group. A characteristic peak of pyridine in PS-b-P4VP/MA was shifted to a higher wavenumber, which indicates an increase in pyridine rigidity due to coordination with metal ions. Also, a characteristic peak of the C═O group was shifted to a higher wavenumber, which indicates that free MA moieties participate in chelation with metal ions.

### 4. Analysis of Chiral Metal Oxide Nanoparticle Arrays (NPs Arrays)

The chiral metal oxide nanoparticle arrays prepared as described in Section 1-2 were analyzed by transmission electron microscopy (TEM), X-ray diffraction (XRD), circular dichroism (CD), UV-vis spectroscopy, g-factor, Tauc plot, X-ray photoelectron spectroscopy (XPS), and magnetic circular dichroism (MCD). The bandgap energy was measured using the Kubelka-Munk function and the Tauc function.

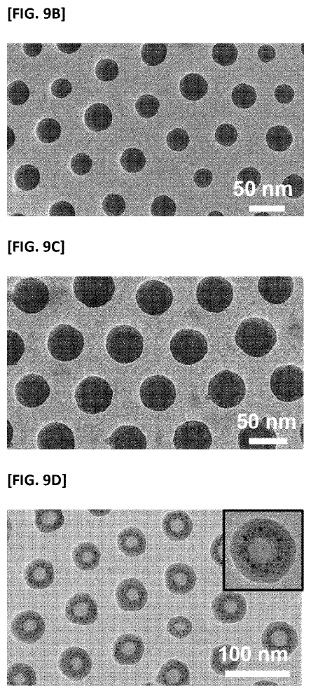

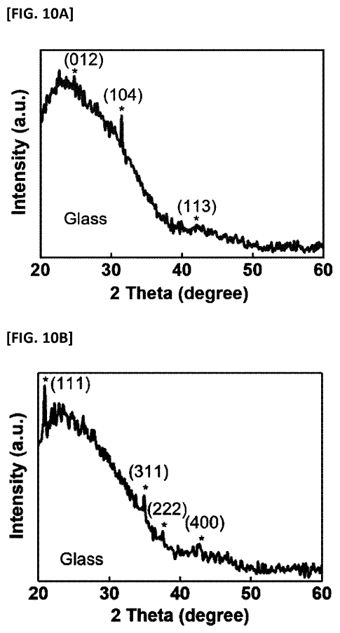

### 4-1. TEM Analysis (FIG. 9A to FIG. 9D)

As shown in FIG. 9A, the chiral Fe₂O₃ oxide nanoparticles has an average diameter of 50 nm and exhibit a regular array with a center-to-center distance of 70 nm.

As shown in FIG. 9B, the chiral Co₃O₄ oxide nanoparticles have an average diameter of about 40 nm and exhibit a regular array with a center-to-center distance of 70 nm.

As shown in FIG. 9C, the chiral CrO₂ oxide nanoparticles have an average diameter of 50 nm and exhibit a regular array with a center-to-center distance of 70 nm.

As shown in FIG. 9D, the chiral CuO oxide nanoparticles have an average diameter of 4 nm within nanoring domains, and the nanoring domains exhibit a regular array with a center-to-center distance of 70 nm.

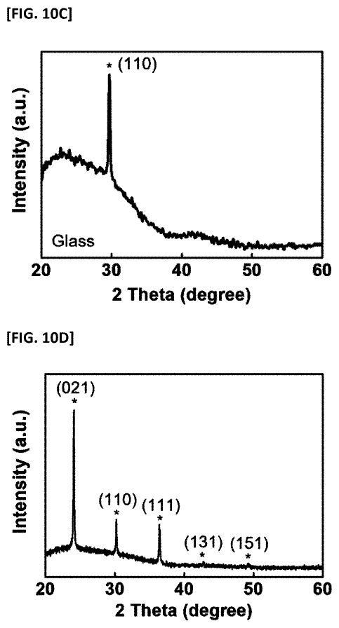

### 4-2. XRD Analysis (FIG. 10A to FIG. 10D)

As shown in FIG. 10A, X-ray diffraction peaks of the chiral Fe₂O₃ nanoparticle array correspond in location to peak characteristics of α-Fe₂O₃ (red iron ore) phase (JCPDS card no. 33-0664).

As shown in FIG. 10B, X-ray diffraction peaks of the chiral Co₃O₄ nanoparticle array correspond in location to peak characteristics of cubic Co₃O₄ phase (JCPDS card no. 43-1003).

As shown in FIG. 10C, X-ray diffraction peaks of the chiral CrO₂ nanoparticle array correspond in location to peak characteristics of orthorhombic CrO₂ phase (JCPDS card no. 84-1819).

As shown in FIG. 10D, X-ray diffraction peaks of the chiral CuO nanoparticle array correspond in location to peak characteristics of monoclinic CuO phase (JCPDS card no. 5-0661).

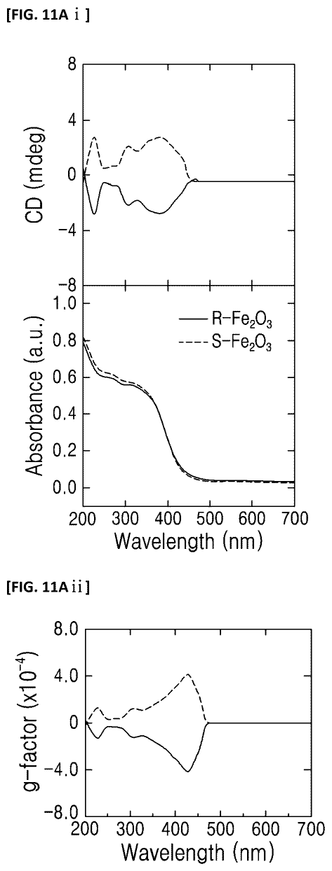

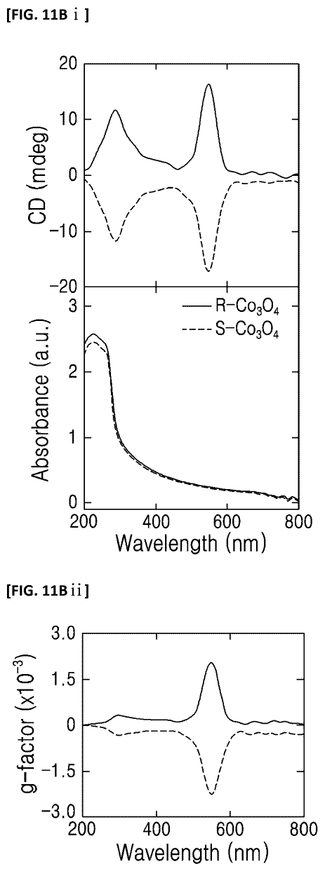

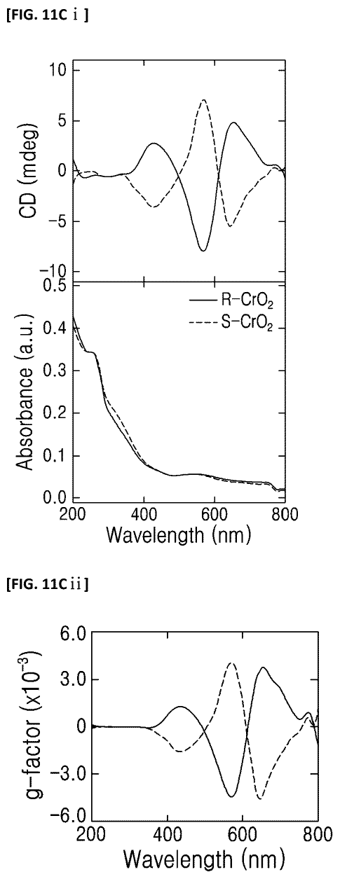

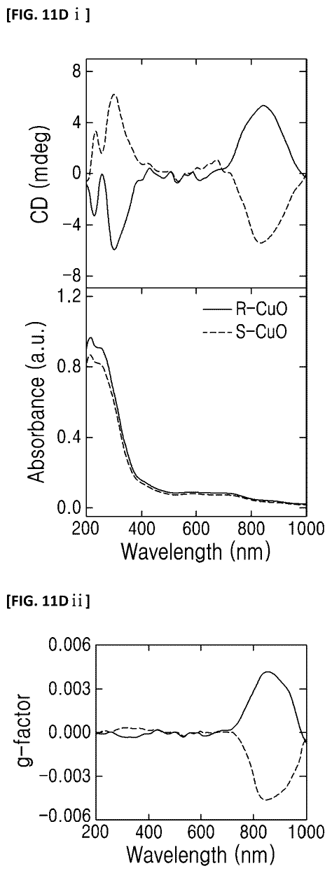

### 4-3. Circular Dichroism, Absorption Spectrum, and G-Factor (FIG. 11Ai and FIG. 11Aii, FIG. 11Bi and FIG. 11Bii, FIG. 11Ci and FIG. 11Cii, and FIG. 11Di and FIG. 11Dii)

As shown in FIG. 11Ai and FIG. 11Aii, for the chiral Fe₂O₃ nanoparticle array, mirror-symmetric circular dichroism peaks appeared at 300 nm and 380 nm corresponding to metal-to-ligand charge transfer (MLCT) and ligand-to-metal charge transfer (LMCT) transitions. Also, a characteristic circular dichroism peak of the residual R/S-MA was observed at 225 nm. The maximum g-factor was measured to be 4.3×10⁻⁴ at 426 nm.

As shown in FIG. 11Bi and FIG. 11Bii, for the chiral Co₃O₄ nanoparticle array, a broad weak band above 500 nm was observed corresponding to MLCT and d-d transitions, along with a distinct absorption band in the UV region corresponding to a Co²⁺ to Co³⁺ transition within the nanoparticles. The CD spectrum exhibited a prominent peak at 550 nm and a weak peak at 287 nm originating from d-d transitions. The maximum g-factor was measured to be 2.3×10⁻³ at 550 nm.

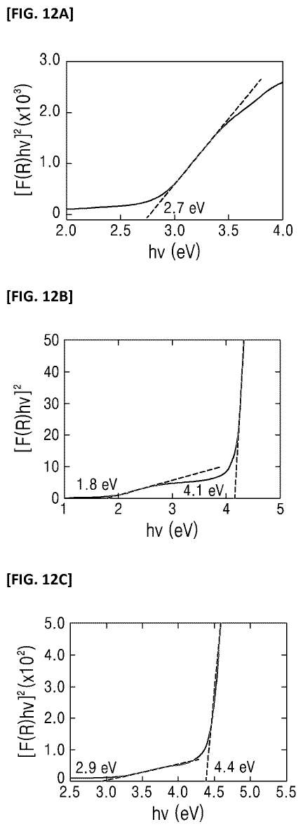

As shown in FIG. 11Ci and FIG. 11Cii, for the chiral CrO₂ nanoparticle array, three absorption bands at 330 nm, 550 nm, and above 600 nm were related to d-d and spin-allowed transitions of Cr³⁺ ions. An absorption band at 250 nm corresponds to the intrinsic bandgap (4.4 eV) of the Cr₂O₃ surface layer, as confirmed by the Tauc plot (FIG. 12A to FIG. 12D). The CD spectrum exhibited strong Cotton effects at 570 nm and 645 nm. The maximum g-factor was measured to be 4.7×10³ at 570 nm and 645 nm.

As shown in FIG. 11Di and FIG. 11Dii, for the chiral CuO nanoparticle array, a sharp band with absorption starting at 400 nm was observed and was related to a direct bandgap of CuO estimated to be 3.2 eV based on the Tauc plot (FIG. 12A to FIG. 12D). A broad absorption band corresponding to a d-d transition appeared above 500 nm. The CD spectrum exhibited perfect mirror symmetry across the entire wavelength range, and absorption-based CD signals and a CD peak of free MA were observed. The maximum g-factor was measured to be 4.7×10⁻³ at 845 nm.

### 4-4. Tauc Plot (FIG. 12A to FIG. 12D)

Referring to FIG. 12A, the direct bandgap energy of the chiral Fe₂O₃ nanoparticle array was estimated to be 2.7 eV by using the Tauc function and was shifted to higher energy compared to bulk Fe₂O₃ due to a quantum size effect.

Referring to FIG. 12B, the Tauc plot of the chiral Co₃O₄ nanoparticle array exhibited two direct bandgaps of 4.1 eV and 1.8 eV corresponding to o²⁻ to O²⁺ and O²⁻ to O³⁺ charge transfer transitions, respectively.

Referring to FIG. 12C, the intrinsic bandgap (4.4 eV) of the Cr₂O₃ surface layer was observed from the Tauc plot of the chiral CrO₂ nanoparticle array, while a bandgap of the CrO₂ nanoparticles was estimated to be 2.9 eV.

Referring to FIG. 12D, a direct bandgap (3.2 eV) of CuO was observed from the Tauc plot of the chiral CuO nanoparticle array.

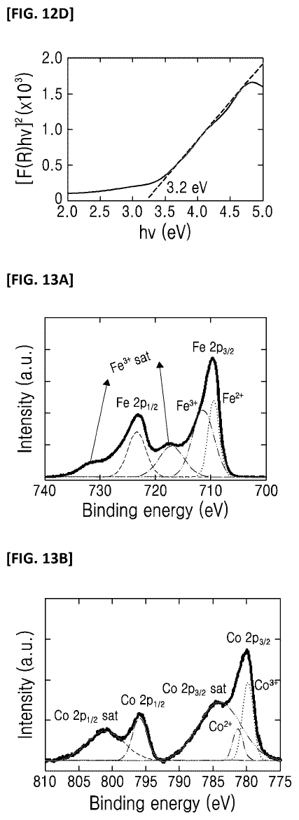

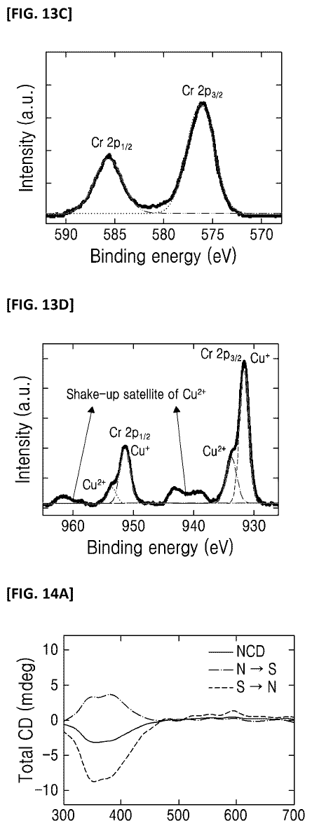

### 4-5. XPS (FIG. 13A to FIG. 13D)

To confirm the oxidation state of the chiral metal oxide nanostructure, X-ray photoelectron spectroscopy (XPS) analysis was performed.

Referring to FIG. 13A, the Fe 2p region of the chiral Fe₂O₃ nanoparticle array indicates that the Fe₂O₃ nanoparticles have both Fe²⁺ and Fe³⁺ oxidation states, which demonstrates that the nanoparticles were partially reduced after oxygen treatment.

Referring to FIG. 13B, the Co 2 p region of the chiral Co₃O₄ nanoparticle array indicates the coexistence of Co²⁺ and Co³⁺ oxidation states in the Co₃O₄ nanoparticles, which demonstrates that Co²⁺ was partially oxidized to Co³⁺ by oxygen treatment.

Referring to FIG. 13C, the Cr 2p region of the chiral CrO₂ nanoparticle array matched standard XPS data of Cr₂O₃, which indicates that a Cr₂O₃ oxide layer was present on the CrO₂ surface because Cr₂O₃ is the most stable phase among Cr oxides.

Referring to FIG. 13D, shake-up satellite peaks of Cu²⁺ ions were observed in the Cu 2p region of the chiral CuO nanoparticle array. However, a metastable Cu₄O₃ phase is formed partially on the surface and Cu²⁺ can be reduced to Cu⁺ under mild conditions, which results in the appearance of a Cu⁺ peak.

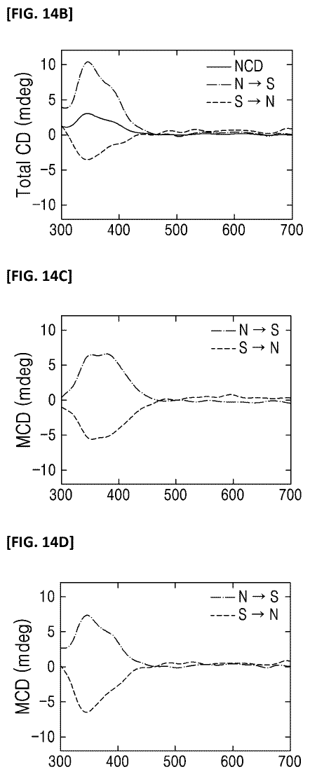

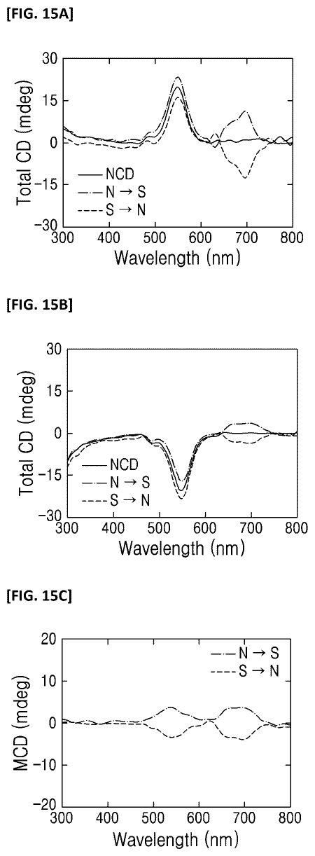

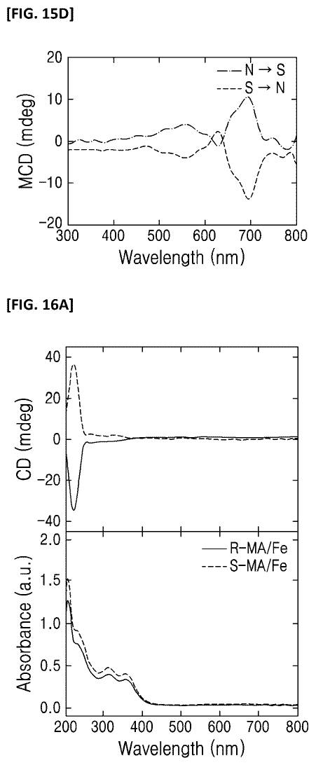

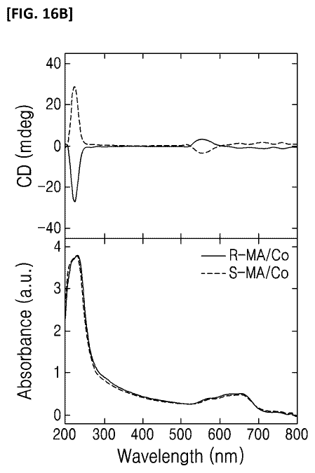

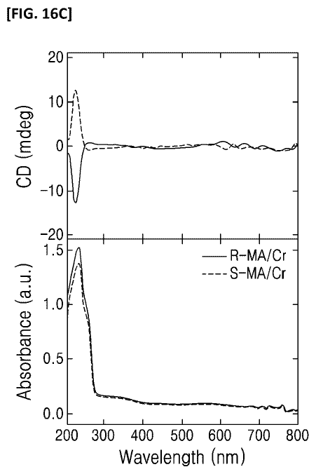

### 4-6. Measurement of Chiral Magneto-Optical Activity (FIG. 14A to FIG. 15B)

The chiral magneto-optical activity was investigated through magnetic circular dichroism (MCD) measurements. In the case of paramagnetic Fe₂O₃ and Co₃O₄, the spin and orbital magnetic moments can align with an external magnetic field. Therefore, the CD and MCD spectra of the chiral Fe₂O₃ and Co₃O₄ nanoparticle arrays were analyzed under parallel and antiparallel magnetic fields of ±1.6 T. In FIG. 14A, FIG. 14B, FIG. 15A and FIG. 15B, the term “NCD (Nature CD)” represents the difference in absorption coefficients of circularly polarized light in the absence of a magnetic field. In contrast, MCD arises from magnetic field-induced Zeeman splitting of electronic states under the external magnetic field. An MCD signal was obtained by excluding an NCD signal from the total CD signal measured under a magnetic field (i.e., MCD=total CD−NCD (B=0)).

Referring to FIG. 14A and FIG. 14B, the total CD spectra of the chiral Fe₂O₃ nanoparticle array were recorded under an external magnetic field. Referring to FIG. 14C and FIG. 14D, when the direction of the applied magnetic field was changed, the signs of the total CD signal corresponding to MLCT and LMCT transitions were completely reversed and the signs of the MCD spectra were inverted.

Referring to FIG. 15A and FIG. 15B, the CD signals originating from LMCT and d-d transitions in the total CD spectra of the chiral CO₃O₄ nanoparticle array under the external magnetic field were significantly influenced by the applied magnetic field. Referring to FIG. 15C and FIG. 15D, the MCD spectra exhibited two peaks at 540 nm and 690 nm, and were vertically inverted when the direction of the applied magnetic field was changed.

Thus, the magnetic field-dependent modulation of a MCD response was confirmed in the visible region based on the spin-polarization dependence of the paramagnetic Fe₂O₃ and CO₃O₄ nanoparticle arrays with respect to the direction of the magnetic field. This result indicates that the chiral metal oxide nanostructures prepared in the present example have potential as magneto-optically active materials for advanced optoelectronic and nonlinear devices.

### 5. Control Experiment

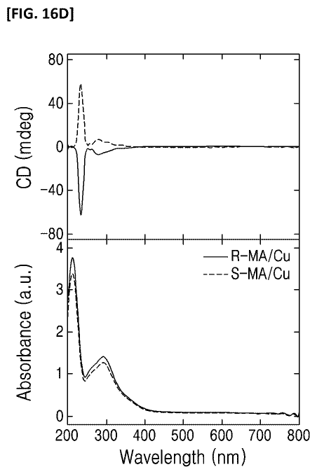

### 5-1. Chiral Analysis of Metal/MA Complex (FIG. 16A to FIG. 16D)

To understand the mechanism of chiral evolution in the chiral metal oxide nanostructures, chiro-optical properties of metal (Fe³⁺, Co²⁺ , Cr³⁺, and Cu²⁺)/MA complexes without containing polymers were examined. MA can be easily racemized in acidic, neutral, or basic media, and when water is used as a solvent, water preferentially reacts with metal ions. Therefore, isopropyl alcohol, which is a very weak acid, was used as a solvent to form complexes.

Referring to FIG. 16A to FIG. 16D, no distinct CD response was detected from the CD spectra of any of the complexes. This indicates that the chirality transfer inducing symmetry breaking at the center of metal was lost, and supports previous studies in which MA has not been used as a chiral inducer to impart chirality to inorganic materials.

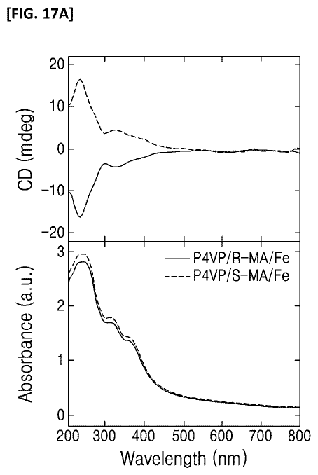

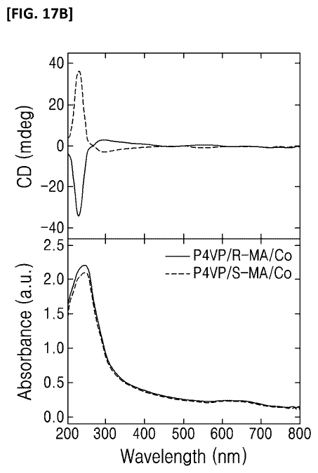

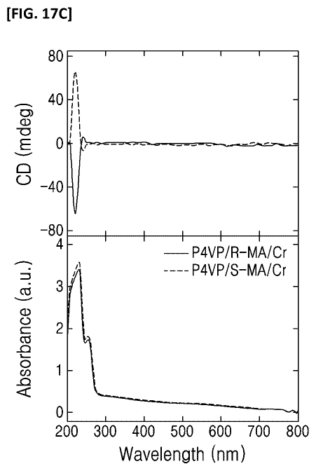

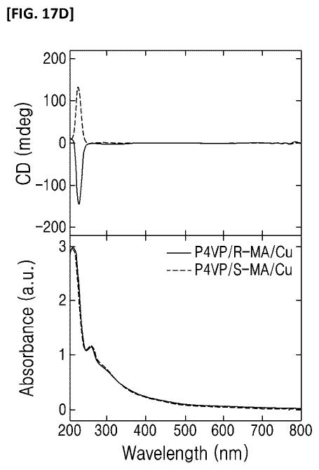

### 5-2. Chiral Analysis of P4VP/MA/Metal Complex (FIG. 17A to FIG. 17D)

To identify the role of P4VP in chiral evolution, chiro-optical responses of P4VP/MA/metal complexes were examined. The P4VP/MA/metal complexes were formed using isopropyl alcohol, which is a very weak acid, for the same reasons described in Section 5-1.

Referring to FIG. 17A to FIG. 17D, the CD spectrum of the P4VP/MA/Fe³⁺ complex (FIG. 17A) exhibited a weak CD signal similar to that of the PS-b-P4VP/MA/Fe³⁺ complex (FIG. 7A), whereas the other P4VP/MA/metal complexes did not exhibit any CD signal, which indicates that a block copolymer reverse micelle template plays a crucial role in chirality transfer to chiral metal oxide nanostructures.

### 6. Hierarchical Chirality Transfer Mechanism

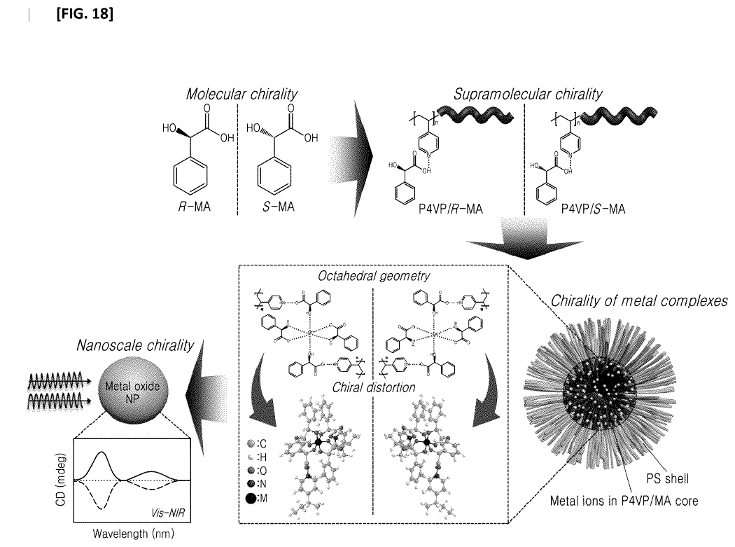

The mechanism of chiral evolution in the chiral metal oxide nanostructures through hierarchical chiral transfer was established based on the present example (FIG. 18). In a metal/MA complex, metal ions are arranged in an octahedral coordination geometry. Considering the molar ratio (1:2) of P4VP/MA, the metal ions can be surrounded by two P4VP/MAs and two MA ligands, which means that the P4VP/MAs are chelated to metal ions through hydroxyl groups and the MA is chelated to metal ions through hydroxyl groups and carboxyl groups in a bidentate coordination mode.

There are two possible origins of chirality of metal/MA complexes: (1) The racemization of MA can be effectively suppressed due to the strong interaction with P4VP and the chelation with metal ions in the confined P4VP micelle core which is encapsulated by the PS shell; (2) Due to the steric hindrance of the bulky P4VP/MA ligands, which is determined by the chirality of MA, the metal ions can be arranged in a severely distorted octahedral geometry. Consequently, the accumulated interactions between P4VP/MA and metal ions in the local environment enable efficient hierarchical chiral transfer from the molecular chirality of MA to the supramolecular chirality of P4VP/MA, and from a metal complex to metal oxide nanoparticles.

### 7. Result

In the present example, a chiral metal oxide nanostructure was synthesized using a universal and facile method based on a chiral reverse micelle template, which was obtained through the co-assembly of a chiral block copolymer and a bulky chiral acid. The strong interactions among P4VP, MA, and metal oxide precursors in the local micelle system effectively suppressed the racemization of MA while facilitating an effective hierarchical chirality transfer to the chiral metal oxide nanostructure. Therefore, MA was used as a chiral inducer, and mirror-symmetric chiro-optical properties were observed in the vis-NIR region, with a maximum g-factor of 4.7×10³. Further, the chiro-optical activity can be regulated under an external magnetic field. The method of fabricating BCP-based chiral metal oxide nanostructures according to the present example enables large-scale production at low cost and achieves adjustable chiro-optical properties by finely controlling various parameters related to a block copolymer self-assembly process.

It would be understood by a person with ordinary skill in the art that various changes and modifications may be made based on the above description without changing technical conception and essential features of the present disclosure. Thus, it is clear that the embodiments are illustrative in all aspects and do not limit the present disclosure. The scope of the present disclosure is defined by the following claims. It shall be understood that all modifications and embodiments conceived from the meaning and scope of the claims and their equivalents are included in the scope of the present disclosure.

The scope of the present disclosure is defined by the following claims rather than by the detailed description of the embodiment. It shall be understood that all modifications and embodiments conceived from the meaning and scope of the claims and their equivalents are included in the scope of the present disclosure.

1. A chiral metal oxide nanostructure, comprising regularly arranged metal oxide nanoparticles, wherein the metal oxide nanoparticles have a spherical shape.

2. The chiral metal oxide nanostructure of claim 1, wherein a metal contained in the chiral metal oxide nanostructure is at least one selected from Fe, Co, Cr, Cu, Ti, V, Mn, Ni, Zn, Zr, Nb, Mo, Ru, Rh, Pd, Ag, Cd, Hf, Ta, W, Ir, Pt, Au, In, Sn, Sb, Pb and Bi.

3. The chiral metal oxide nanostructure of claim 1, wherein a crystal structure of the metal oxide nanoparticles is selected from cubic, orthorhombic, and monoclinic structures.

4. The chiral metal oxide nanostructure of claim 1, wherein a diameter of the metal oxide nanoparticles is 10 nm to 100 nm.

5. The chiral metal oxide nanostructure of claim 1, wherein the chiral metal oxide nanostructure is applied in chiral sensing, chiral catalysis, chiral devices, chiral materials, and chiral optics.

6. A method of preparing the chiral metal oxide nanostructure according to claim 1, comprising:
a) adding a block copolymer and mandelic acid to a nonpolar solvent to prepare a first solution including a block copolymer/mandelic acid complex;
b) adding a metal oxide precursor to the first solution to prepare a second solution; and
c) treating the second solution with oxygen plasma to obtain the chiral metal oxide nanostructure.

7. The method of claim 6, wherein the block copolymer is composed of a combination of a nonpolar polymer and a polar polymer, or a combination of a nonpolar polymer and a hydrophilic polymer.

8. The method of claim 6, wherein the block copolymer includes at least one selected from polystyrene-block-poly(4-vinyl pyridine) (PS-b-P4VP), polystyrene-block-poly(methylmethacrylate) (PS-b-PMMA), polystyrene-block-poly (ethylene oxide) (PS-b-PEO), polystyrene-block-poly(vinyl pyridine) (PS-b-PVP), polystyrene-block-poly (acrylic acid) (PS-b-PAA), and polystyrene-block-polyisoprene (PS-b-PI).

9. The method of claim 6, wherein the mandelic acid is selected from R-mandelic acid and S-mandelic acid.

10. The method of claim 6, wherein the nonpolar solvent includes at least one selected from toluene, acetone, benzene, xylene, chloroform, tetrahydrofuran, dimethylformamide, and isopropanol.

11. The method of claim 6, wherein a metal contained in the metal oxide precursor and the chiral metal oxide nanostructure includes at least one selected from Fe, Co, Cr, Cu, Ti, V, Mn, Ni, Zn, Zr, Nb, Mo, Ru, Rh, Pd, Ag, Cd, Hf, Ta, W, Ir, Pt, Au, In, Sn, Sb, Pb and Bi.

12. The method of claim 6, wherein the block copolymer/mandelic acid complex has a reverse micelle structure.

13. The method of claim 6, wherein the block copolymer/mandelic acid complex has a core-shell structure.

14. The method of claim 6, wherein the process b) includes adding the metal oxide precursor to N,N-dimethylformamide.

15. The method of claim 6, wherein the process c) further includes drop-casting the second solution, evaporating the solvent, and performing oxygen plasma treatment to obtain the chiral metal oxide nanostructure.
